(19) United States
(12) Patent Application Publication
(10) Pub. No.: US 2004/0104495 A1
(43) Pub. Date: Jun. 3, 2004

(54) Expanding dental model material

(76) Inventor: Jurgen Laubersheimer, Karlsbad (DE)

Correspondence Address: NATH & ASSOCIATES, 1030 15th STREET, 6TH FLOOR, WASHINGTON, DC, 20005, US

(21) Appl. No.: 10/472,561

(22) PCT Filed: Nov. 23, 2001
(86) PCT No.: PCT/EP01/13640

(30) Foreign Application Priority Data
Mar. 26, 2001 (DE) 101-15-820.3

(51) Int. Cl. A61C 13/00

(52) U.S. Cl. 264/16; 264/489; 523/109

(57) ABSTRACT

The invention describes a model material for dental purposes which has a linear expansion on setting or curing of at least 0.5%, preferably at least 1%. The model material is preferably a dental plaster which has a relatively high volume expansion on setting compared to dental plasters customary hitherto as a result of the use of appropriate additives and/or make-up liquids. The use of these model materials for producing working models enables the sintering shrinkage occurring during sintering to be compensated for in the production of full-ceramic shaped dental parts.

The invention relates to a model material for dental purposes and to a process for producing a dental model, in particular a dental working model.

Ceramic or “porcelain” has always been an attractive material for reproducing teeth having a very tooth-like appearance in terms of shape and color. Ceramic is a chemically resistant, corrosion-resistant and biocompatible material which is, in addition, available in mineral form in virtually unlimited quantities and is thus inexpensive. Individual replacement teeth can be produced simply and reproducibly from this material using dental technology methods, so that the term “dental ceramic” has become established for this material.

To overcome the single weakness of this material, viz. the brittleness, tooth replacement material produced by dental technology methods has generally been produced as a classical composite material, e.g. as metal ceramic, for a long time. A metal-ceramic crown or bridge consists of a metallic framework or substructure and a blend of dental ceramic reproducing the shape of the tooth. When the tooth replacement is installed, the substructure is fixed directly onto the remainder of the tooth after preparation by the dentist and is often referred to as a (protective) cap. Depending on the material or alloy making up the cap and depending on the production method (casting, electroforming methods, i.e. electrochemical deposition), problems in the form of corrosion and resulting discoloration, incompatibility with the body, etc., can occur. For this reason, there has in recent years been increasing development of systems which can produce comparable subconstructions of ceramic materials and process them further by dental technology methods.

There are a number of functioning systems on the dental market. Thus, ceramic caps are produced, for example, by manual application of a slip onto a model stump, subsequent firing and subsequent infiltration with special glass (VITA In-Ceram) or by hot pressing (Empress, IVOCLAR). There are also systems in which the caps are digitally machined from sintered or presintered ceramic blocks (DCS System, CEREC, etc.). However, all such full ceramic systems generally do not achieve an accurate fit of the metallic bodies to the remaining tooth, regardless of whether the bodies have been cast or produced by electrolytic processes. In addition, these systems are usually very expensive to purchase.

The unsatisfactory accuracy of fit of existing full ceramic systems is mainly due to the shaping methods used. Metallic caps are produced by casting or electrodeposition, so that the metal in molten or dissolved form can optimally match the stump geometry. In contrast, in the case of, for example, CADCAM full ceramic processes, the required shape has to be machined from solid material according to a digitally recorded data set. However, the scanning of the tooth stump and the machining can, depending on the digital resolution of the system components, introduce inaccuracies.

A further fundamental difficulty associated with all existing or future systems for producing full-ceramic tooth replacements from sintered ceramic materials in respect of the accuracy of fit of the finished parts is the ceramic shrinkage, i.e. the volume shrinkage of shaped ceramic parts associated with the densifying sintering process. Although this sintering shrinkage can be reduced within certain limits, it cannot be completely avoided. For this reason, the sintering shrinkage associated with the sintering step is, for example, avoided indirectly by shaping previously sintered ceramic (CADCAM methods, see above) or seeking to achieve a pore-free solid microstructure in another way (glass infiltration of the soft, porous ceramic cap in the InCeram process, see above). In electrophoretic deposition of ceramic particles, too, the shaped ceramic part obtained has to be subsequently sintered, so that the indicated problem of sintering shrinkage also occurs here.

It is therefore an object of the invention to help achieve a high accuracy of fit with the base structures for which they are intended in the production of full-ceramic dental components. In particular, the adverse effects of the abovementioned sintering shrinkage should be avoided.

This object is achieved by the model material having the features of claim 1 and by the process having the features of claim 8. Preferred embodiments of this model material and this process are described in the dependent claims 2 to 7 and 9 to 13, respectively. The wording of all claims is hereby incorporated by reference into the present description.

To give a better understanding of the invention, the production and further processing of dental models will be explained briefly below. The tooth or the teeth which is/are to be provided with a shaped dental part, e.g. crown, bridge or the like, is/are prepared in a known manner by the dentist. An implant buildup part can also serve as starting point. The dentist takes an imprint of this oral situation by means of a curable elastomer material. This can be, for example, a silicone polymer. The imprint obtained in this way represents a negative model of the preparation carried out by the dentist. This imprint, i.e. the negative model, is handed over to the dental technician who makes a casting from this imprint with the aid of a suitable model material, usually a dental plaster. Setting of the plaster gives a positive model, viz. the master model, which corresponds precisely to the preparation performed by the dentist. This master model is usually retained as reserve pattern. It is used for producing one or more working models which are then processed further. The working model is produced by duplication, i.e. a negative model is produced with the aid of a duplicating material, for example silicone polymer, which is then once again filled with dental plaster. A further positive model, namely the working model, is produced in this way.

In accordance with the procedure just described, it has hitherto been obvious to a person skilled in the art that he should use a model material having a very low expansion on setting or curing. This is because it is only in this way that the required accuracy of reproduction of dimensions between the preparation performed by the dentist and then the master model or working model can be ensured. For this reason, the expansion on setting of, for example, customary model materials such as dental plasters is generally very low. This expansion on setting can be determined by Customary methods according to the known relationships of dilatometry as linear expansion Δl/l₀ or volume expansion ΔV/V₀. The linear expansion of commercial dental plasters, e.g. the change in length experienced by a corresponding plaster body on setting, is less than 0.3%. Very low values are sought in principle. Thus the linear expansion values of the frequently employed superhard plasters of the class IV are ≦0.15%.

In contrast, the model material of the present invention for dental purposes has a linear expansion on setting or curing of at least 0.5%, preferably at least 1%. Preferred values for the linear expansion on setting/curing are in the range from 4% to 12%. Within this range, preference is in turn given to values of from 8% to 10%.

A model material as provided by the invention completely contradicts the previous understanding of a person skilled in the art. As explained above, it has previously been the aim to provide model materials having a very low expansion on setting/curing. The invention now intentionally focuses on model materials having relatively high expansions in order to compensate for the sintering shrinkage occurring in the production of full-ceramic shaped dental parts. If the master model or preferably the working model is deliberately “overdimensioned”, the sintering shrinkage can be accepted. If the expansion behavior of the model material and the sintering shrinkage behavior of the ceramic are known, an accurately dimensioned full-ceramic shaped dental part can be made available.

The model material can in principle consist of a wide variety of substances which can also be organic in nature. However, in preferred embodiments of the invention, the model material consists mainly and in particular entirely of inorganic substances. If desired, additives which influence the expansion on setting or other chemical and physical properties of the model material can be present. These additives, too, are preferably inorganic substances.

Particular preference is given to the model material of the invention consisting entirely or mainly of gypsum plaster. In the present case, these are then generally dental plasters which take account of the particular requirements in the dental sector, for example in terms of modelability and drawing accuracy. In terms of its overall properties, gypsum plaster remains the model material of choice for the dental technician. To achieve accurate processing appropriate to the product, gypsum plaster is suitable for all types of models in dental technology and their production.

Finely pulverulent dental plaster, chemically CaSO₄.½H₂O (“calcium sulfate hemihydrate”), is mixed with a particular amount of water (H₂O) and used for producing plaster duplicates of teeth or dentures. The plaster slurry formed on mixing is introduced into a readily removable mold made of duplicating material (usually silicone) which corresponds to the imprint of the oral situation. The mixture then sets by reaction with water to form CaSO₄.2H₂O, viz. calcium sulfate dihydrate:

CaSO₄.½H₂O+1½H₂O→CaSO₄.2H₂O

As can be seen from the chemical formula, part of the water added is bound chemically as “water of crystallization” on setting. During the setting process, the plaster solidifies and becomes hard. Heat is liberated and the process is accompanied by a reproducible expansion which can be determined as linear expansion Δl/l or as volume expansion ΔV/V. This expansion is low in the case of the dental plasters known hitherto and is deliberately set to a high value in the case of the dental plasters of the invention.

When examined in detail, the setting process is a sum of individual processes. Mixing of the dry plaster powder with water forms a supersaturated solution of calcium sulfate hemihydrate which takes up water and turns into dihydrate. Starting from crystallization nuclei, clusters grow by uptake of further dihydrate molecules and continue to grow to form crystals. The formation of new nuclei and the continual growth of the dihydrate crystals thus slowly produces an evermore solid network of mutually interlocking and interpenetrating crystals whose volume is greater than the sum of the individual crystal volumes. This is reflected macroscopically in that the plaster experiences the abovementioned (volume) expansion on setting. In addition, energy is released in the form of heat.

As already mentioned, further preferred embodiments of the model material of the invention further comprise additives which influence, in particular, the setting and curing process. Such additives influence parameters such as the expansion on setting/curing, the duration of setting/curing, the hardness of the model obtained and the like. The additives are preferably inorganic substances, in particular salts. Thus, for example, addition of sodium chloride can increase the volume expansion of dental plasters on setting. However, preference is given to using silicates as additive for increasing the volume expansion. Such silicates can, for example, be used in the form of silica sol. According to the invention, it is possible to add the silicates to the gypsum plaster powder either directly or in the form of silicate-containing make-up liquids.

The process which is likewise encompassed by the invention is employed for producing a dental model, in particular a dental master model or preferably working model. This process is characterized in that the model is shaped from a model material having a relatively high expansion and this model is subsequently allowed to set or cure. As stated above, the model material has a linear expansion of at least 0.5%, preferably at least 1%. In preferred embodiments of the process of the invention, the above-described model material according to the invention is used.

The expansion of the model which is obtained in the process of the invention can be additionally increased in a desirable fashion by dipping the shaped model at least partly, preferably completely, into a liquid, in particular a solvent, for a particular time during setting/curing. The liquid is preferably the liquid with which the model material has been admixed, in particular stirred, to bring it into the slurry or paste form necessary for casting into the mold. When dental plaster is used as model material, this liquid is usually water. In these cases, the plaster material is accordingly allowed to set under water.

In the process of the invention, further preference is given to the model obtained after setting/curing being at least partially dried. This is usually carried out by simply allowing the model to stand in air, for which a period of from 0.5 hour to 3 hours is usually sufficient. During drying, the water which is not chemically bound as water of crystallization in the plaster evaporates. The drying process can be aided by employing elevated temperatures. In preferred embodiments of the process of the invention, at least one microwave drying step is employed for drying the models. Microwave drying generally takes only a few minutes and can be carried out in a customary domestic microwave oven.

Finally, the invention provides for the use of the above-described model materials of the invention for producing full-ceramic shaped dental parts. Here, the sintering shrinkage occurring during sintering of the shaped dental parts formed on a master model or working model is at least partly, preferably fully, compensated for by the volume expansion occurring in the production of the master model/working model. In this context, express reference is made to the description above. As described above, the model material of the invention, the process of the invention and the use according to the invention ensure that the full-ceramic shaped dental parts fit accurately onto the preparation produced in the mouth by the dentist.

In the production of full-ceramic shaped dental parts, the preferred procedure is to apply a suspension of ceramic particles, namely the ceramic slip, to the model, usually a working model. This working model has been produced from the model material of the invention and accordingly has, owing to the volume expansion which has occurred, larger dimensions than the base structure prepared in the mouth by the dentist. Accordingly, this working model usually also has larger dimensions than the master model which is intended to reproduce the oral situation exactly and is advantageously not produced from the model material according to the invention. The larger dimensions of the working model onto which the ceramic slip is applied take account of the sintering shrinkage occurring in the sintering step.

In this context, it may be mentioned that the working model finally used for application of the ceramic slip can according to the invention also be produced in a plurality of passes, depending on which model material according to the invention is used. In this way, the desired larger dimensions of the working model to compensate for the sintering shrinkage can be approached gradually or it may even be possible to produce various full-ceramic shaped parts and test their fit to the master model.

If the full-ceramic shaped part is to be permanently joined in the mouth to the base structure present there (nonremovable tooth replacement), the thickness of the layer of adhesive or tooth cement necessary to fix the shaped part in the mouth can additionally be taken into account in the production of the model (working model).

This is of course not necessary in the case of a removable tooth replacement.

The ceramic suspension can advantageously be applied to the model (working model) by electrophoretic deposition. The principles of and the procedure for such an electrophoretic deposition are known to those skilled in the art. In this procedure, a powder, in this case a ceramic powder, dispersed in a liquid is deposited on the model as a precompacted layer with the aid of an electric field. The ceramic body obtained in this way, viz. the green body, is sintered, if appropriate after drying and detachment from the model.

In electrophoretic shaping, the model of the oral situation (working model) to which an electric contact has been applied, e.g. by means of conductive silver paint, is connected as electrode into an electric circuit. As counterelectrode, use is made of, for example, a Pt electrode whose shape can be varied according to the shape of the model so as to achieve a highly homogeneous electric field over the entire model.

The deposition of the ceramic slip on the working model is carried out at constant voltage or at constant current, normally over a period of from 1 to 60 minutes. Typical values for the deposition voltage and the deposition current are from 1 to 100 V and from 0 to 500 mA, respectively. The green densities obtained when using electrophoretic deposition are usually greater than 70%, preferably greater than 80%, of the theoretical density. Electrophoretic deposition can, if appropriate, be carried out in an automated fashion with the aid of an appropriate apparatus.

The suspensions of ceramic particles used are suspensions of dispersed ceramic powders in suitable solvents. As indicated above, these are also referred to as ceramic slips. As solvents, preference is given to using polar solvents, in particular water, alcohols and mixtures thereof or mixtures of water with alcohols. Preference is given to using polar solvents having dielectric constants in the range from 15 to 85, preferably in the range from 15 to 20.

The ceramic particles are preferably oxide ceramic particles, in particular aluminum oxide (Al₂O₃) particles and/or zirconium oxide (ZrO₂) particles, or mixtures thereof. The particle sizes of the ceramic particles are preferably in the range from 1 nm to 100 μm, preferably from 100 nm to 10 μm. In particular, the ceramic particles are present in the suspension in an amount of from 10 to 90 percent by weight, preferably from 40 to 60 percent by weight, based on the total weight of the suspension.

In further embodiments, at least two fractions of ceramic particles having different mean particle sizes can be present within the suspension. In this way, it is possible to increase the density of the deposited green body, since the ceramic particles having a smaller mean particle size at least partly fill the interstices between the ceramic particles having a larger mean particle size. It is known that the particle size distribution of a fraction of ceramic particles having a particular mean particle size conforms to a Gauss distribution. Accordingly, the two or more Gauss curves are shifted relative to one another in the embodiments described (in order to remain in this picture).

The suspension usually further comprises binders which preferably comprise at least one polyvinyl alcohol or at least one polyvinyl butyral. Such binders serve, inter alia, to improve both the drying behavior and the strengths of the resulting green bodies. The binders are preferably present in the suspension in amounts of from 0.1 to 20 percent by weight, in particular from 0.2 to 10 percent by weight, based on the solids content of the suspension.

The slips used have viscosities in the range from 1 mPa*s to 50 mPa*s, preferably in the range from 3 to 10 mPa*s, at a shear rate of 600 s⁻¹ The zeta potentials of the slips obtained by means of the added dispersant are in the range from ±1 mV to ±100 mV, preferably from ±30 mV to ±50 mV.

The green body produced in this way preferably has an average layer thickness of from 0.2 to 2 mm, in particular from 0.8 to 1.2 mm. In this way, the desired layer thicknesses of the full-ceramic shaped part after the sintering step can be achieved.

The green ceramic body is sintered at temperatures determined by the ceramic materials used. The sintering temperature is preferably in the range from 1100° C. to 1700° C., in particular from 1150° C. to 1300° C. The sintering temperature is preferably about 1200° C.

The sintering time is likewise chosen, for example, as a function of the ceramic material used. Here, preferred sintering times are from 2 to 10 hours, in particular from 4 to 6 hours. In further, preferred embodiments, sintering is carried out for about 5 hours.

To achieve a homogeneous temperature distribution in the green body, it is gradually brought to the final sintering temperature. Preferred heating rates are from 1 to 20° C./min, in particular from 5 to 10° C./min. Within the latter range, heating rates of from 5 to 7.5° C./min are most preferred.

The preferred procedure in the sintering step is to dry the working model together with the green body deposited thereon in air at room temperature and then to transfer it to the furnace. There, the working model together with the green body is heated to about 900° C., for which it is possible to use a comparatively low heating rate. This heating can be carried out in steps, with hold times at the appropriate temperatures being able to be provided. This heating results in presintering of the green body, with the gypsum material of the working model shrinking since the calcium sulfate dihydrate loses some of its water of crystallization. The working model together with the green body is then briefly taken from the furnace and the green body is detached from the working model. This occurs easily since the working model has shrunk, as described above. The presintered green body, for example in the form of a cap, is then put back in the furnace. The furnace is then brought to the final sintering temperature, preferably at a comparatively high heating rate, and the shaped part is fully sintered.

After the sintering step, full-ceramic shaped parts having densities of more than 90% of the theoretical density, preferably more than 95% of the theoretical density, are obtained. Such full-ceramic parts, for example in the form of a cap, can then be provided in a customary fashion, like a metal cap, with facing ceramic and fired. This produces the final tooth replacement which is, for example, fitted in the form of a crown or bridge into the mouth of the patient. It is of course also possible for the tooth replacement produced in this way to be fitted on top of dental supraconstructions, for example implant parts.

Further features of the invention can be derived from the following examples in conjunction with the subordinate claims. The individual features can in each case be realized either alone or in combinations of two or more thereof.

### EXAMPLES

### Example 1

A commercial dental plaster will firstly be used to show that the volume expansion of such model materials can be increased by means of appropriate measures. The experiments described below are carried out using a commercial dental plaster of class II, namely the “Alamo” dental plaster from Hinrichs, Germany. According to the data provided by the manufacturer, this dental plaster has a linear expansion on setting of 0.29%. A mixing ratio of 100 g of plaster powder to 50 ml of water is indicated.

### Example 1a

### Effect of Siliceous Additives

100 g of the abovementioned plaster powder are mixed with 50 ml of a 10% strength silica sol solution (Catalogue No. 33,844-3 from Aldrich Chemicals) and subsequently stirred under reduced pressure for 30 seconds. The plaster slurry obtained in this way is introduced on a shaker into duplication molds made of silicone. The duplication molds reproduce the shape of the prepared tooth stump. After a setting time of 25 minutes, the plaster model is removed from the duplication mold and dried in air for one hour. The linear expansion on setting (length change after setting) measured subsequently is 0.5%.

### Example 1b

### Effect of Setting Under Water

100 g of the plaster powder and 50 ml of water are mixed and subsequently stirred under reduced pressure for 30 seconds. The plaster slurry obtained in this way is introduced on a shaker into duplication molds made of silicone. After a setting time of 20 minutes, the plaster model is removed from the duplication mold. The plaster model is subsequently allowed to set under water for a further 60 minutes. The linear expansion on setting is 0.6%.

### Example 1c

### Effect of Siliceous Additives and Setting Under Water

100 g of the plaster powder and 50 ml of a 10% strength silica sol (Catalogue No. 33,844-3 from Aldrich Chemicals) are mixed and subsequently stirred under reduced pressure for 30 seconds. The plaster slurry obtained in this way is introduced on a shaker into duplication molds made of silicone. After a setting time of 20 minutes, the plaster model is removed from the duplication mold. This plaster model is subsequently allowed to set under water for 60 minutes. A drying step of 1 hour in air is then carried out. The linear expansion on setting of the gypsum model obtained is 0.7%.

### Example 2

A commercial dental plaster of class III, from Heraeus, type “Moldano”, color: light blue, has, according to the data from the manufacturer, a linear expansion on setting in accordance with EN ISO 6873 of 0.16% after a setting time of 40 minutes.

The processing of this plaster was used as an example to demonstrate, compared to the standard procedure (1), the expansion-increasing effect of setting under water (2), siliceous additives to the plaster (3), an additional siliceous make-up liquid (4) and the effect of all three measures together (5):

(1) 100 g of plaster powder and 30 ml of water are mixed manually, subsequently stirred under reduced pressure for 40 seconds, introduced into an extensometer with gentle shaking and the expansion on setting is subsequently measured in accordance with EN ISO 6873. After a setting time of 40 minutes, the linear expansion on setting is 0.16%.

(2) 100 g of plaster powder and 30 ml of water are mixed manually, subsequently stirred under reduced pressure for 40 seconds, introduced into an extensometer with gentle shaking and the expansion on setting is subsequently measured in accordance with EN ISO 6873, with water being dribbled continually over the plaster mass so as to keep it wet. After a setting time of 40 minutes, the linear expansion on setting is 0.31%.

(3) A mixture of 90 g of plaster powder, 10 g of montmorillonite sheet silicate (montmorillonite K-10, Aldrich Chemicals) and 40 ml of water is produced manually, subsequently stirred under reduced pressure for 40 seconds, introduced into an extensometer with gentle shaking and the expansion on setting is subsequently measured in accordance with EN ISO 6873. After a setting time of 40 minutes, the linear expansion on setting is 0.38%.

(4) A mixture of 90 g of plaster powder, 10 g of montmorillonite sheet silicate (montmorillonite K-10, Aldrich Chemicals), 30 ml of water and 10 ml of silica sol is produced manually, subsequently stirred under reduced pressure for 40 seconds, introduced into an extensometer with gentle shaking and the expansion on setting is subsequently measured in accordance with EN ISO 6873. After a setting time of about 30 minutes, the linear expansion on setting is 0.61%.

(5) A mixture of 90 g of plaster powder, 10 g of montmorillonite sheet silicate (montmorillonite K-10, Aldrich Chemicals), 30 ml of water and 10 ml of silica sol is produced manually, subsequently stirred under reduced pressure for 40 seconds, introduced into an extensometer with gentle shaking and the expansion on setting is subsequently measured in accordance with EN ISO 6873, with water being continually dribbled over the plaster mass so as to keep it wet. After a setting time of about 30 minutes, the linear expansion on setting is 1.06%.

1. A model material for dental purposes, characterized in that it has a linear expansion on setting or curing of at least 0.5%, preferably at least 1%.

2. A model material as claimed in claim 1, characterized in that it has a linear expansion of from 4% to 12%, preferably from 8% to 10%.

3. A model material as claimed in claim 1 or claim 2, characterized in that it consists of an inorganic material which may contain additives.

4. A model material as claimed in claim 3, characterized in that it consists of dental plaster.

5. A model material as claimed in any of the preceding claims, characterized in that it contains at least one inorganic additive, preferably at least one inorganic salt.

6. A model material as claimed in claim 5, characterized in that the inorganic additive is at least one silicate.

7. A model material as claimed in claim 5 or claim 6, characterized in that the inorganic additive is a silica sol.

8. A process for producing a dental model, in particular a dental working model, characterized in that the model is shaped from a model material which has a linear expansion on setting or curing of at least 0.5%, preferably at least 1%, and the model obtained in this way is subsequently allowed to set or is cured.

9. The process as claimed in claim 8, characterized in that the model is shaped from a model material as defined in any of claims 2 to 7.

10. The process as claimed in claim 8 or claim 9, characterized in that the setting or curing step is at least partly, preferably entirely, carried out under at least one liquid, preferably under water.

11. The process as claimed in any of claims 8 to 10, characterized in that the model is dried after the setting or curing step.

12. The process as claimed in claim 11, characterized in that drying is carried out by allowing to stand in air, preferably for a period of from about 30 minutes to about 3 hours.

13. The process as claimed in claim 11, characterized in that drying is carried out with the aid of microwaves.

14. The use of a material which has a linear expansion on setting or curing of at least 0.5%, preferably at least 1%, for producing full-ceramic shaped dental parts, where the sintering shrinkage which occurs on sintering a green ceramic body formed on a working model is compensated for at least partly, preferably fully, by the expansion of the model material in the production of the working model.

15. The use as claimed in claim 14, characterized in that the model material is an inorganic material, preferably dental plaster.
